(19) United States
(12) Patent Application Publication
(10) Pub. No.: US 2015/0364251 A1
(43) Pub. Date: Dec. 17, 2015

(54) SINTERED MAGNET PRODUCTION METHOD

(71) Applicants: INTERMETALLICS CO., LTD., Nakatsugawa-shi (JP); DAIDO STEEL CO., LTD., Nagoya-shi (JP)

(72) Inventors: Masato SAGAWA, Kyoto-shi (JP); Norio YOSHIKAWA, Nagoya-shi (JP)

(73) Assignees: INTERMETALLICS CO., LTD., Nakatsugawa-shi (JP); DAIDO STEEL CO., LTD., Nagoya-shi (JP)

(21) Appl. No.: 14/765,160

(22) PCT Filed: Feb. 3, 2014
(86) PCT No.: PCT/JP2014/052413

§ 371 Date: Jul. 31, 2015

(30) Foreign Application Priority Data
Feb. 5, 2013 (JP) 2013-020343

(51) Int. Cl. H01F 41/02; B22F 3/10; B22F 3/24; H01F 1/08; C22C 38/00; H01F 1/053; H01F 1/057; B22F 9/04; C22C 33/02

(52) U.S. Cl. CPC H01F 41/0253; B22F 9/04; B22F 3/1007; B22F 3/24; C22C 33/02; C22C 38/005; C22C 38/002; H01F 1/0536; H01F 1/0577; H01F 1/086; B22F 2003/248

(57) ABSTRACT

A method having a pulverizing process in which a lump of alloy of a material for a sintered magnet is pulverized by a method including a hydrogen pulverization method, filling process wherein a cavity is filled with alloy powder obtained by pulverizing process, an orienting process wherein alloy powder is magnetically oriented by applying magnetic field to alloy powder, and sintering process wherein alloy powder is sintered by heating it according to predetermined temperature history. In the sintering process, alloy powder is heated in inert-gas atmosphere at higher pressure than atmospheric pressure until temperature reaches predetermined pressurization maintenance temperature which is higher than hydrogen desorption temperature and equal to or lower than sintering temperature. By performing the heating treatment in a pressurized inert gas, hydrogen-gas molecules remaining in the alloy powder are prevented from suddenly desorbing from alloy powder, so that the cracking of the sintered magnets hardly occurs.

### TECHNICAL FIELD

The present invention relates to a method for producing a sintered magnet containing a rare-earth element R, such as an RFeB system (R₂Fe₁₄B) or RCo system (RCo₅ or R₂Co₁₇).

### BACKGROUND ART

For the production of sintered magnets, a method has been conventionally used which includes the steps of pulverizing a lump of starting alloy into fine powder with an average particle size of approximately a few to a dozen μm (such powder is hereinafter called the “alloy powder”) (pulverizing process), filling a cavity of a container with the alloy powder (filling process), applying a magnetic field to the alloy powder in the cavity to magnetically orient the particles of the alloy powder (orienting process), applying pressure to the alloy powder to produce a compression-molded compact (compression-molding process), and heating the compression-molded compact to sinter it (sintering process). In this method, the orienting process also requires an application of a mechanical pressure to the alloy powder; otherwise, the particles of the alloy powder which have been methodically oriented would be disordered in the compression-molding process. A variation of this method has also been used in which, after the cavity has been filled with the alloy powder, the orienting process and the compression-molding process are simultaneously performed by applying a magnetic field to the alloy powder while applying pressure with a pressing machine. In any cases, compression molding is performed using a pressing machine. Therefore, in the present application, these methods are called the “pressing method.”

Meanwhile, in recent years, it has been found that a sintered magnet having a shape corresponding to the cavity can be obtained without performing the compression-molding process, by a method in which the alloy powder that has been placed in the cavity is oriented in a magnetic field and subsequently, directly subjected to the sintering process (Patent Literature 1). In the present application, such a method of producing a sintered magnet without the compression-molding process is called the “press-less method.” The press-less method is advantageous in that better magnetic properties can be obtained since the magnetic orientation of the alloy-powder particles is not impeded by a mechanical pressure.

### CITATION LIST

### Patent Literature

Patent Literature 1: JP 2006-019521 A

### Non Patent Literature

Non Patent Literature 1: J. M. D. Coey, ed., Rare-earth Iron Permanent Magnets, Clarendon Press, published by Oxford University Press, 1996, p. 353

### SUMMARY OF INVENTION

### Technical Problem

In any of the pressing and press-less methods, the alloy powder is normally prepared as follows: Initially, a lump of starting alloy is made to occlude hydrogen-gas molecules so as to embrittle the lump of the starting alloy, and subsequently, this lump is either made to spontaneously decay or be crushed by a mechanical force to obtain coarse powder with an average particle size of tens to hundreds of μm (hydrogen pulverization). Next, this coarse powder is further ground by a jet-mill method or the like to produce fine powder (alloy powder) with an average particle size of approximately a few to a dozen μm. However, it has been known that, if alloy powder thus prepared using the hydrogen pulverization method is used, the eventually obtained sintered magnets will have cracks with a comparatively high probability.

The problem to be solved by the present invention is to provide a sintered magnet production method in which cracking hardly occurs in the sintered magnets to be produced.

### Solution to Problem

The present invention developed for solving the previously described problem is a sintered magnet production method having a pulverizing process in which a lump of alloy of a material for a sintered magnet is pulverized by a method including a hydrogen pulverization method, a filling process in which a cavity is filled with alloy powder obtained by the pulverizing process, an orienting process in which the alloy powder held in the cavity is magnetically oriented by applying a magnetic field to the alloy powder, and a sintering process in which the alloy powder is sintered by heating the alloy powder to a predetermined sintering temperature, wherein:

in the sintering process, the alloy powder is heated in an inert-gas atmosphere at a higher pressure than atmospheric pressure until the temperature reaches a predetermined pressurization maintenance temperature equal or higher than a hydrogen desorption temperature as well as equal to or lower than the sintering temperature.

The “hydrogen desorption temperature” in the present invention is defined as follows: If an amount of alloy powder with hydrogen occluded is left in vacuum, a trace amount of hydrogen desorbs from the alloy powder even at room temperature. If this alloy powder is heated in vacuum, the hydrogen suddenly begins to desorb more intensely than at room temperature as soon as the heating temperature exceeds a certain level. This temperature is defined as the “hydrogen desorption temperature.” The hydrogen desorption temperature depends on the composition of the alloy powder. For example, for an alloy powder of Nd₂Fe₁₄B, the sudden desorption of hydrogen begins at approximately 70° C. (see Non Patent Literature 1).

According to the present invention, while the temperature is being raised from the hydrogen desorption temperature to the pressurization maintenance temperature, the heating treatment is performed in an inert-gas atmosphere at a pressure equal to or higher than atmospheric pressure, whereby the hydrogen-gas molecules occluded in the alloy powder are prevented from suddenly desorbing from the alloy powder. Thus, the cracking of the sintered magnet due to the sudden desorption of the hydrogen-gas molecules is suppressed.

As the inert gas, helium gas, argon gas and other kinds of noble gas, as well as a mixture of those kinds of gas, can be used. Using a gas that is not inert should be avoided in order to prevent reaction with the alloy powder.

In the present invention, any of the pressing and press-less methods may be used. That is to say, the process of press-molding the alloy powder may be performed during the orienting process or between the orienting and sintering processes (pressing method), or the press-molding may not be performed (press-less method).

In any of the pressing and press-less methods, it is often the case that a surface active agent is added in the pulverizing process (particularly, fine pulverization process) and/or orienting process in order to prevent reaggregation of fine particles (with a particle size of approximately a few to a dozen μm) of the alloy powder. As the surface active agent, a commercially available organic lubricant is used. If this organic lubricant is not removed before the sintering but is allowed to be heated with the alloy powder in the sintering process, the carbon atoms in the organic lubricant will be mixed in the main phase of the sintered magnet and thereby lower the coercive force.

In the present invention, if an alloy powder with an organic lubricant added is used in the pulverizing and/or orienting process, controlling the sintering process in the previously described manner to gradually desorb hydrogen-gas molecules from the alloy powder allows the hydrogen gas to react with the organic lubricant and causes hydro-cracking of the molecules of the organic lubricant (the cracking reaction of hydrocarbon). This facilitates vaporization of the organic lubricant, so that the amount of carbon atoms to be eventually contained in the sintered magnet will be decreased and ultimately the coercive force will be improved.

In the sintered magnet production method according to the present invention, after the pressurization maintenance temperature is reached, the heating treatment should preferably be performed in vacuum atmosphere. This increases the sintered density.

If the material of the alloy powder is Nd₂Fe₁₄B, an Nd-rich phase with Nd as the primary component is normally formed between the main phases composed of Nd₂Fe₁₄B within the particle of the alloy powder. Suppose that such an alloy powder is heated in vacuum. Initially, when the temperature has reached in the vicinity of the aforementioned level of 70° C., desorption from the main phase begins to occur more intensely than at room temperature, which becomes most intense at temperatures around 120° C. After that, desorption of hydrogen molecules from the Nd-rich phase begins when the temperature has reached in the vicinity of 200° C., which becomes most intense at temperatures around 600° C. Accordingly, in the case of using Nd₂Fe₁₄B as the material of the alloy powder, the treatment in the inert-gas atmosphere at a higher pressure than atmospheric pressure should preferably be performed until the temperature becomes 200° C. or higher, preferably 400° C. or higher, and more preferably 600° C. or higher.

### Advantageous Effects of the Invention

According to the present invention, the hydrogen-gas molecules remaining in the alloy powder are prevented from suddenly desorbing in the sintering process, whereby the cracking of the sintered magnet is suppressed.

In the case where an alloy powder to which an organic lubricant (surface active agent) is added is used in the pulverizing and/or orienting process, the hydrogen-gas molecules which gradually desorb from the alloy powder in the sintering process can react with the organic lubricant, which consequently reduces the amount of decrease in the coercive force due to the carbon atoms.

### BRIEF DESCRIPTION OF DRAWINGS

FIG. 1 is a chart showing the flow of the processes in one embodiment of the sintered magnet production method according to the present invention.

FIG. 2 is a graph showing a temperature history of the sintering process in the sintered magnet production method according to the present embodiment.

FIG. 3 is a graph showing the occurrence ratio of the cracking of sintered magnets produced by the sintered magnet production method of the present embodiment and that of a comparative example.

FIG. 4 is a graph showing the result of measurements of the carbon content and coercive force of sintered magnets produced by the sintered magnet production method of the present embodiment and that of the comparative example.

### DESCRIPTION OF EMBODIMENTS

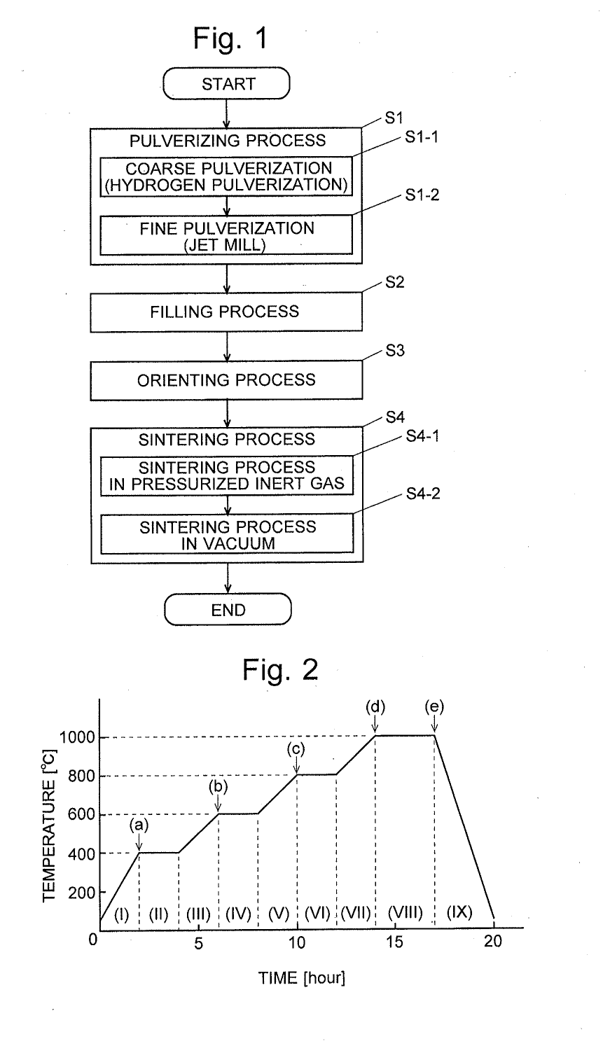

One embodiment of the sintered magnet production method according to the present invention is described using FIGS. 1-4.

### Embodiment

The descriptions in the present embodiment will be mainly concerned with the case of using the press-less method. As shown in FIG. 1, the sintered magnet production method of the present embodiment has four processes: the pulverizing process (Step S1), filling process (Step S2), orienting process (Step S3) and sintering process (Step S4). Among those processes, the pulverizing process (Step S1) includes two sub-processes: the coarse pulverization process (Step S1-1) and fine pulverization process (Step S1-2). The sintering process (Step S4) includes two sub-processes: the sintering process in pressurized inert gas (Step S4-1) and sintering process in vacuum (Step S4-2). Each of those processes will be hereinafter described.

Before the coarse pulverization process, a lump of alloy of NdFeB, SmCo or similar system to be used as the material for the sintered magnet is prepared. A plate-shaped lump of alloy produced by strip casting can be preferably used. In the coarse pulverization process (Step S1-1), the lump of alloy of the NdFeB, SmCo or similar system to be used as the material for the sintered magnet is exposed to hydrogen gas to make the lump of alloy occlude the molecules of the hydrogen gas. Although some portion of the hydrogen-gas molecules are occluded in the main phase, most of those molecules are occluded in the rare-earth rich phase in the lump of alloy. A rare-earth rich phase is a phase which contains the rare-earth element (e.g. Nd or Sm) at a higher percentage than the main phase (e.g. Nd₂Fe₁₄B, SmCo₅ or Sm₂Co₁₇) in the lump of alloy, and which exists between the main phases. The hydrogen occlusion which mainly occurs in the rare-earth rich phase causes the rare-earth rich phase to expand and become brittle. The embrittled lump of alloy can be made to spontaneously decay or be crushed by a mechanical force, to obtain coarse powder with an average particle size from tens to hundreds of In this coarse pulverization process, after the hydrogen gas is occluded in the lump of alloy, an organic lubricant can be added to prevent reaggregation of the particles of the coarse powder.

Subsequently, in the fine pulverization process (Step S1-2), the coarse powder is further ground by a jet mill or similar device to obtain fine powder (alloy powder) with an average particle size of approximately a few to a dozen μm. In this fine pulverization process, an organic lubricant can be further added to prevent aggregation of the particles of the fine powder.

In the filling process (Step S2), the alloy powder is put in a container. In the orienting process (Step S3), a magnetic field is applied to the alloy powder in the container to magnetically orient the alloy powder. In the present embodiment, since the press-less method is used, the compression-molding of the alloy powder is not performed in the filling and orienting processes. A detailed description of the filling and orienting processes in the press-less method can be found in Patent Literature 1. If the pressing method is used, a green compact of the alloy powder is produced by performing a press-molding operation using a pressing machine simultaneously with the application of the magnetic field to the alloy powder in the orienting process, or after the orienting process.

In the sintering process (Step S4), the magnetically oriented alloy powder in the state of being held in the container is placed in a sintering chamber. In the case of the pressing method, a green compact is placed in the sintering chamber instead of the alloy powder held in the container.

The temperature in the sintering chamber is changed as follows: Initially, (i) the temperature is increased to a sintering temperature, which is normally within a range from 900° C. to 1100° C. (this is hereinafter called the “temperature-increasing phase”). Subsequently, (ii) the sintering chamber is maintained at the sintering temperature for a couple of hours (hereinafter, the “high-temperature phase”), after which (iii) the chamber is cooled (hereinafter, the “cooling phase”). How the atmosphere within the sintering chamber is controlled during these phases (i)-(iii) will be hereinafter described.

In the present embodiment, the heat treatment of the alloy powder is performed in the sintering chamber filled with inert gas at a higher pressure than atmospheric pressure (i.e. in the pressurized state) from the beginning of the temperature-increasing phase until a predetermined temperature (pressurization maintenance temperature) is reached (the sintering process in pressurized inert gas: Step S4-1). The present embodiment allows the pressurized state to be maintained until the sintering temperature is reached (i.e. the pressurization maintenance temperature may be set at the sintering temperature), in which case the pressurized state may be maintained until the high-temperature phase is completed.

As the inert gas, a kind of noble gas (e.g. argon gas), nitrogen gas, or a mixture of those kinds of gas can be used.

After the pressurized state is completed, the sintering chamber is evacuated by a vacuum pump to maintain a high-vacuum atmosphere of 10 Pa or lower pressure until the high-temperature phase is completed (the sintering process in vacuum: Step S4-2). The sintering process in vacuum will be omitted in the case where the pressurization by the inert gas is maintained until the high-temperature phase is completed. In the cooling phase, after the evacuation is discontinued, the inert gas with a low temperature (room temperature) is introduced into the sintering chamber. This inert gas may be introduced either at atmospheric pressure or under a higher amount of pressure than atmospheric pressure.

After the sintering process, an after-treatment is performed as needed, such as the aging treatment for correcting the crystalline structure of the main phase by heating the alloy powder or the green compact at a lower temperature (e.g. 520° C.) than the sintering temperature.

In the present embodiment, the hydrogen-gas molecules which have been occluded in the alloy powder as a result of the hydrogen pulverization in the coarse pulverization process are released from the alloy powder by being heated in the sintering process. During this process, the atmosphere surrounding the alloy powder is maintained in the inert-gas atmosphere with a higher pressure than atmospheric pressure until the pressurization maintenance temperature is reached. Therefore, the hydrogen-gas molecules will not be suddenly released but gradually desorbed from the alloy powder. Thus, the cracking of the sintered magnet due to a sudden desorption of the hydrogen-gas molecules is suppressed.

Furthermore, in the present embodiment, the organic lubricant added to the lump of alloy material in the pulverizing process reacts with the hydrogen-gas molecules desorbed from the alloy powder (the cracking reaction of hydrocarbon) in the sintering process and becomes easier to vaporize. As a result, the amount of carbon atoms to be eventually contained in the sintered magnet will be decreased, so that the coercive force will be improved.

The result of an experiment in which sintered magnets were produced by the, sintered magnet production method of the present embodiment is hereinafter described. In the present experiment, NdFeB system sintered magnets were produced by the press-less method. The lubricant added in the pulverizing process was methyl myristate. In the sintering process, the alloy powder was heated so that the temperature history would be as shown in FIG. 2. Specifically, the sequence was as follows: The temperature was (I) increased from room temperature to 400° C. in two hours, (II) maintained at 400° C. for two hours, (III) increased from 400° C. to 600° C. in two hours, (IV) maintained at 600° C. for two hours, (V) increased from 600° C. to 800° C. in two hours, (VI) maintained at 800° C. for two hours, (VII) increased from 800° C. to 1000° C. in two hours, (VIII) maintained at 1000° C. (the sintering temperature) for three hours, and (IX) decreased to room temperature in three hours.

In the experiment, after the sintering chamber was filled with argon gas of 120 kPa (approximately 1.2 atmospheric pressure) at room temperature, the temperature within the sintering chamber was increased. Four experiments were performed, with the pressurization by the argon gas respectively performed (a) until the end of phase (I) (the pressurization maintenance temperature: 400° C.), (b) until the end of phase (III) (600° C.), (c) until the end of phase (V) (800° C.) and (d) until the end of phase (VII) (1000° C., the sintering temperature). One more experiment was performed, with the pressurization by the argon gas continued (e) until the end of phase (VIII), i.e. until the operation of maintaining the sintering temperature was completed. The evacuating operation was not performed in case (e). The pressure within the sintering chamber was maintained at the aforementioned level by releasing a portion of the argon gas in the sintering chamber through a valve in each temperature-increasing phase or replenishing the chamber with argon gas in the temperature-decreasing phase.

For comparison, another experiment (comparative example) was also performed, in which the sintering chamber was continuously evacuated from the beginning of the temperature-increasing operation until the end of phase (VIII), without pressurization by the argon gas.

In each of the experiments (a)-(e) and comparative example, 500 pieces of sintered magnets were produced, and the occurrence ratio of cracking was calculated by dividing the number of cracked sintered magnets by the number of produced ones. Furthermore, in each experiment, one of the produced sintered magnets was randomly chosen, and its carbon content (in weight percentage) and coercive force were measured.

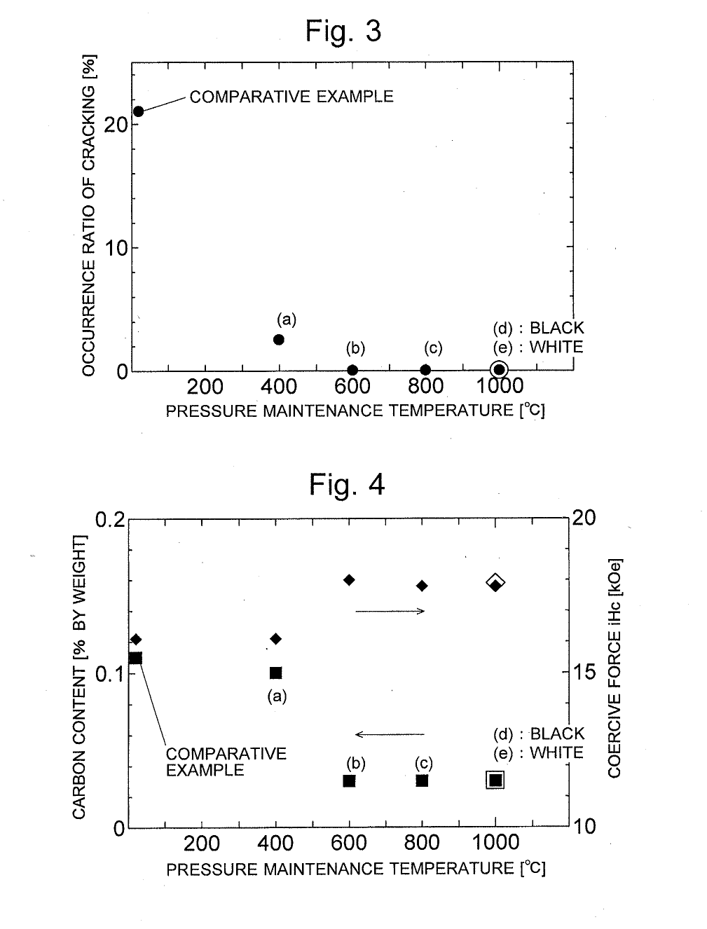

FIG. 3 shows the calculated result of the occurrence ratio of cracking by means of a graph. In comparative example, cracks were found in 21.0% of the produced sintered magnets. By contrast, in the present embodiment, cracks were found in 2.5% of the sintered magnets produced in case (a) in which the pressurization maintenance temperature was set at a lower level than in the other cases of the present embodiment. Nevertheless, this occurrence ratio is as low as approximately one tenth of the comparative example. In cases (b)-(e), the cracking did not occur in any of the sintered magnets (the occurrence ratio was 0%). These results demonstrate that the cracking of sintered magnets can be dramatically suppressed or totally eliminated by the present embodiment.

The probable reason why cracking occurred in a small number of sintered magnets in experiment (a) is that, although the pressurization maintenance temperature was certainly higher than the temperature at which the desorption (from the main phase) begins (70° C.), it was lower than the temperature at which the desorption from the Nd-rich phase peaks (600° C.), and therefore, was insufficient for completely suppressing the desorption of the hydrogen gas from the Nd-rich phase. By contrast, the probable reason why cracking could be totally eliminated in experiments (b)-(e) is that the pressurization maintenance temperature was equal to or higher than the temperature at which the desorption from the Nd-rich phase peaks, so that the desorption of the hydrogen gas from not only the main phase but also the Nd-rich phase could be suppressed.

FIG. 4 shows the result of measurements of the carbon content and coercive force by means of a graph. In comparative example, the carbon content was 0.11% by weight and the coercive force was 16.1 kOe. In case (a) of the present embodiment, the carbon content was 0.10% by weight, slightly lower than the comparative example, while the coercive force was equal to the comparative example, i.e. 16.1 kOe. Thus, while showing the previously described noticeable effect of suppressing the cracking of the sintered magnets, case (a) was not significantly effective for reducing the carbon content and improving the coercive force. By contrast, in any of the cases (b)-(e), the carbon content was 0.03% by weight (in all cases (b)-(e)) and hence lower than the comparative example, while the coercive force was higher than the comparative example, ranging from 17.8 to 18.0 kOe. Thus, cases (b)-(e) showed noticeable effects not only in terms of the cracking of the sintered magnets but also in terms of the reduction of the carbon content and the improvement of the coercive force. Such a difference between case (a) and the other cases (b)-(e) is most likely due to the same reason as in the case of the cracking of the sintered magnets, i.e. it probably depends on whether the pressurization maintenance temperature is lower (case (a)) or not lower (cases (b)-(e)) than the temperature at which the desorption from the Nd-rich phase peaks.

1. A sintered magnet production method having a pulverizing process in which a lump of alloy of a material for a sintered magnet is pulverized by a method including a hydrogen pulverization method, a filling process in which a cavity is filled with alloy powder obtained by the pulverizing process, an orienting process in which the alloy powder held in the cavity is magnetically oriented by applying a magnetic field to the alloy powder, and a sintering process in which the alloy powder is sintered by heating the alloy powder to a predetermined sintering temperature, wherein:
in the sintering process, the alloy powder is heated in an inert-gas atmosphere at a higher pressure than atmospheric pressure until a temperature reaches a predetermined pressurization maintenance temperature equal or higher than a hydrogen desorption temperature as well as equal to or lower than the sintering temperature.

2. The sintered magnet production method according to claim 1, wherein the sintering process includes a step of performing a heating treatment in vacuum atmosphere after a heating treatment in the inert-gas atmosphere is completed.

3. The sintered magnet production method according to claim 1, wherein the material of the alloy powder is Nd₂Fe₁₄B, and the pressure maintenance temperature is 400° C. or higher.

4. The sintered magnet production method according to claim 3, wherein the pressure maintenance temperature is 600° C. or higher.

5. The sintered magnet production method according to claim 2, wherein the material of the alloy powder is Nd₂Fe₁₄B, and the pressure maintenance temperature is 400° C. or higher.

6. The sintered magnet production method according to claim 5, wherein the pressure maintenance temperature is 600° C. or higher.
